(19) United States
(12) Patent Application Publication
(10) Pub. No.: US 2021/0374722 A1
(43) Pub. Date: Dec. 2, 2021

(54) METHOD AND SYSTEM FOR CONTROLLING DISPLAY OF A REPRESENTATION OF A PHYSICAL USER TOKEN IN A DIGITAL WALLET

(71) Applicant: Loyalty Angels Ltd, Ascot, Berkshire (GB)

(72) Inventor: David Ian Gower, Ascot, Berkshire (GB)

(21) Appl. No.: 17/059,869

(22) PCT Filed: Jun. 5, 2019
(86) PCT No.: PCT/GB2019/051554

§ 371 Date: Nov. 30, 2020

(30) Foreign Application Priority Data
Jun. 5, 2018 (GB) 1809224.7

(51) Int. Cl. G06Q 20/36; G06Q 20/32; G06Q 20/22; H04L 29/08

(52) U.S. Cl. CPC G06Q 20/363; H04L 67/26; G06Q 20/227; G06Q 20/3221

(57) ABSTRACT

A method for controlling display of a graphical representation of a physical user token in a digital wallet application of an electronic device, where the graphical representation is specified by a token server of a token-issuing entity is described. The method comprises: receiving, at a central processing system, user token user-specified data from the electronic device, the user-specified data comprising a unique token identifier that represents the physical user token and an image identifier representing a user-determined image associated with the physical token; linking, at the central processing system, the unique token identifier with the image identifier; sending an update instruction from the central processing system to the token server, to update graphical asset data associated with the physical user token stored at the token server, the instruction including the image identifier and the unique token identifier, updating the graphical asset data associated with the physical user token stored at the token server, with the received image identifier and unique token identifier; transmitting from the token server, asset information relating to the graphical representation to the electronic device, the asset information being generated using the image identifier and the unique token identifier; and using the received asset information to display the graphical representation in the digital wallet application of the electronic device.

### TECHNICAL FIELD

The present disclosure relates to methods and systems for controlling display of a representation of a physical user token in a digital wallet application of an electronic device.

### BACKGROUND

It is becoming more common for consumers to utilise a digital wallet to transfer money for goods and/or services. A digital wallet is typically an electronic device that allows a user to make transactions electronically. The electronic device is typically a mobile telecommunications device, such as, for example, a smartphone, and will generally employ near-field communication (NFC) or a similar short-range communication protocol to enable swift, contactless payment.

To be able to perform electronic transactions using a digital wallet, a consumer, or user, is required to upload information relating to their physical Payment Card(s) to a digital wallet payment system using a digital wallet application (such as Apple Pay, Android Pay) operating on the electronic device. This information can be uploaded to the digital wallet application using the device camera, by manually entering the card details, or by importing the data from a separate application.

A user's digital wallet may be used instead of a physical wallet. Rather than carrying around a bulky physical wallet containing all of their physical payment cards and loyalty tokens, the user may upload each of their cards to the digital wallet so that only their mobile device is required to perform transactions. This saves the user the hassle of carrying around many different cards for different purposes, and also removes the possibility of losing cards or having cards stolen.

However, the user's physical payment cards may be decorated with images that are specific to the user and have been created using a personalisation service provided by a payment card provider. In other circumstances, some of the user's payment cards may have been purchased through a specific promotion, such as a collaboration between a football club and card provider for example, and therefore may have specific artwork associated with it that is important to the user. The advantage of having different images for each card is that each card becomes identifiable by the user quickly purely based on the images of the cards. This is particularly important when only part of the card image is viewable when in a wallet configuration (as per FIG. 1)

In contrast, because graphics used on payment cards shown in the digital wallet are supplied from a graphic asset vault provided by a payment service provider (PSP), and are based on a generic BIN (Bank Identification Number), the image on the physical payment card may not correspond to the graphics shown on the representation of the payment card in the digital wallet. The BIN, which is an identifier that is unique to the payment card provider only, is the mechanism by which specific graphics data is linked to a particular payment card. It is not possible, therefore, to identify the year of issue of the physical card, the promotion by which the physical card was obtained, or any other image present on the physical card at the time of issue by using the BIN alone. This gives rise to the situation where the representations of payment cards issued by one payment card provider cannot be differentiated in the digital payment wallet because each BIN is assigned generic graphics, and all cards having that BIN have a representation bearing those graphics in the digital payment wallet. For example, as shown in the example ‘wallet’ 50 of FIG. 1, the two payment card 52, 54 representations at the top of the wallet 50 correspond to payment cards that link to different accounts but the graphics on each are the same because they share the same BIN.

This is a particularly important consideration as there is typically limited screen space on the electronic device, such as a smartphone, which is running the digital wallet application due to the small size of the device screen. This limited screen space means that display all of the multitude of different cards which the user may have in the digital wallet is difficult and necessarily involves overlapping of images and obscuring of others (as seen in FIG. 1). As only small portion of the digital representation of the card may be visible this can cause problems. More specifically, an inability to differentiate between two or more payment cards in the digital wallet may cause unwanted delays and/or mistakes regarding which particular payment card is used.

Moreover, the server networks and databases of the payment service provider's system are not configured to be able to implement an update to each card or to individually personalise specific graphics within a digital wallet. The system presently being used is a system that must interact with both physical payment schemes and digital wallets as well as other payment card systems, and so is an old, legacy system. To alter the internal functions of the system to accommodate individual alteration of graphics in the graphic asset vault would require an overhaul of current operating practices and systems. This may cause problems with the speed of operation of the system and may cause problems for users.

The present invention seeks to address at least this problem. More specifically, though not exclusively the present invention seeks to provide a retrofitting solution which can work with existing legacy systems.

### SUMMARY OF INVENTION

According to one aspect of the present invention there is provided a method for controlling display of a graphical representation of a physical user token in a digital wallet application of an electronic device, where the graphical representation is specified by a token server of a token-issuing entity, the method comprising: receiving, at a central processing system, user-specified data from the electronic device, the user-specified data comprising a unique token identifier that represents the physical user token and an image identifier representing a user-determined image associated with the physical token; linking, at the central processing system, the unique token identifier with the image identifier; sending an update instruction from the central processing system to the token server, to update graphical asset data associated with the physical user token stored at the token server, the instruction including the image identifier and the unique token identifier, updating the graphical asset data associated with the physical user token stored at the token server, with the received image identifier and unique token identifier; transmitting from the token server, asset information relating to the graphical representation to the electronic device, the asset information being generated using the image identifier and the unique token identifier; and using the received asset information to display the graphical representation in the digital wallet application of the electronic device.

A method of the kind described above is particularly advantageous as it allows users to update card graphics information where they would not have previously been able to. Ordinarily, the legacy systems of payment service providers that are required to interact with digital wallet applications are unable to provide graphics image data based upon PANs as all card data is stored based on BINs, or Bank Identification Numbers. Embodiments of the present invention make use of the fact that the payment service provider graphic assets vaults are accessible via an API that accepts information relating to PAN and metadata including image details, without requiring redesign of the entire system to accommodate user preference in image data.

Advantageously, users can associate any user selected image with a token. This helps to personalise the payment wallet and also enables optimisation of colours and designs of the graphical representations to make the most effective use of the limited screen size of most electronic wallet devices, such a smartphones running a digital payment wallet app.

In some embodiments the receiving step comprises receiving user preference data as the image identifier, the user preference data indicating an image, and the method further comprises obtaining the image identifier based on the user preference data.

The method may further comprise providing a selection of image data at the electronic device and generating the user preference data based on the user selection of image data.

The receiving step may comprise receiving the unique token identifier and obtaining the image identifier based on the unique token identifier. In this case the obtaining step may comprise comparing the unique token identifier with a library of token identifiers and extracting an image identifier associated with the unique token identifier, the library being external to the central processing system. In certain embodiments the image identifier represents a pre-approved image forming part of a library of pre-approved images.

The receiving step may comprise receiving image data representing a captured image of the physical user token, and the obtaining step may comprise obtaining the image identifier for the captured image using image recognition.

The linking step may comprise storing the token identifier and the image identifier in a data store of the central processing system. Alternatively the linking step may comprise updating an existing entry in the data store relating to the token identifier with the received image identifier.

In some embodiments, the linking step comprises determining whether a pre-determined criteria has been met, and if so updating the image identifier in the central data store based on the pre-determined criteria.

The sending step may comprise sending the update instruction to an API of the token server. This is an easy way to access the token server to change the images defined by the token server.

The method may further comprise transmitting the token identifier to a tokenizing platform and receiving an encoded token identifier representing the token identifier, In this case the sending step may comprise sending the update instruction to the token server via the tokenizing platform, the unique token identifier comprising the encoded token identifier and converting the encoded token identifier into an un-encoded token at the tokenizing platform before transmitting the same to the token server. Use of the tokenizer increases security within the system.

The asset information may comprise one of the group comprising an image, a location of the graphical assets stored at the token server and a location of an image stored at the token server. Alternatively, the asset information may provide a location in an image store of the electronic device and the using step comprises retrieving the image from the image store of the electronic device.

In some embodiments the asset information comprises a location of metadata and the method further comprises using the metadata to enable the electronic device to retrieve the graphical representation.

The transmitting step may comprise transmitting the asset information to the electronic device via a push notification. This is a convenient way of updating the digital wallet. Alternatively, the transmitting step may comprise transmitting the asset information when the digital wallet application is updated.

According to another aspect of the present invention there is provided a system for controlling display of a graphical representation of a physical user token in a digital wallet application of an electronic device, where the graphical representation is specified by a token server of a token-issuing entity, the system comprising the electronic device, central processing server and the token server, wherein the central processing system includes: a receiver for receiving user-specified data from the electronic device, the user-specified data comprising a unique token identifier that represents the physical user token and an image identifier representing a user-determined image associated with the physical token; a controller for linking the unique token identifier with the image identifier; and a transmitter for sending an update instruction to the token server, to update graphical asset data associated with the physical user token stored at the token server, the instruction including the image identifier and the unique token identifier; the token server being arranged to: update the graphical asset data associated with the physical user token stored at the token server, with the received image identifier and unique token identifier; and transmit asset information relating to the graphical representation to the electronic device, the asset information being generated using the image identifier and the unique token identifier; and the electronic device being arranged to use the received asset information to display the graphical representation in the digital wallet application of the electronic device.

The present invention can also be realised in each of the separate components of the above described system, namely in a separate electronic device configured to operate with the above system, a central processing server configured to operate according to the above-described method and a token server configured to operate according to the above described method. In this regard it should be noted that only part of the above described method may be implemented on the specific component.

### BRIEF DESCRIPTION OF DRAWINGS

One or more embodiments of the invention will now be described, by way of example only, with reference to the accompanying drawings, in which:

FIG. 1 is an illustration of a conventional digital wallet with a list of payment cards having generic graphics based on BIN number;

FIG. 2 is a schematic block diagram showing a communications network and various interacting parties of a system according to an embodiment of the invention;

FIG. 3 is a schematic block diagram of the electronic device used in the system of FIG. 2;

FIG. 4 is a schematic block diagram of he central processing system of the system of FIG. 2;

FIG. 5 is a schematic block diagram illustrating a PSP, electronic device, and central processing system, and the interactions therebetween;

FIG. 6 is a flow chart detailing a method of enroling a payment card for controlling display of a representation of the payment card according to an embodiment of the present invention; and

FIG. 7 is a flow chart showing a method of operation of the PSP, electronic device and the central processing system of FIG. 5.

### DETAILED DESCRIPTION

When used herein, the term ‘graphics’ is used to refer to any static or moving image or any visual art that may be displayed on a display of an electronic device. For example, the graphics may comprise a short animation in the form of a GIF, or a movie. Alternatively, graphics may refer to an icon with which the user can interact. The term ‘image’ is used herein to describe static images only, such as those found on physical payment cards.

When used herein, the term ‘payment card’ may refer to either a physical payment card or an electronic representation of a payment card within a digital wallet, depending upon the context in which the term is used.

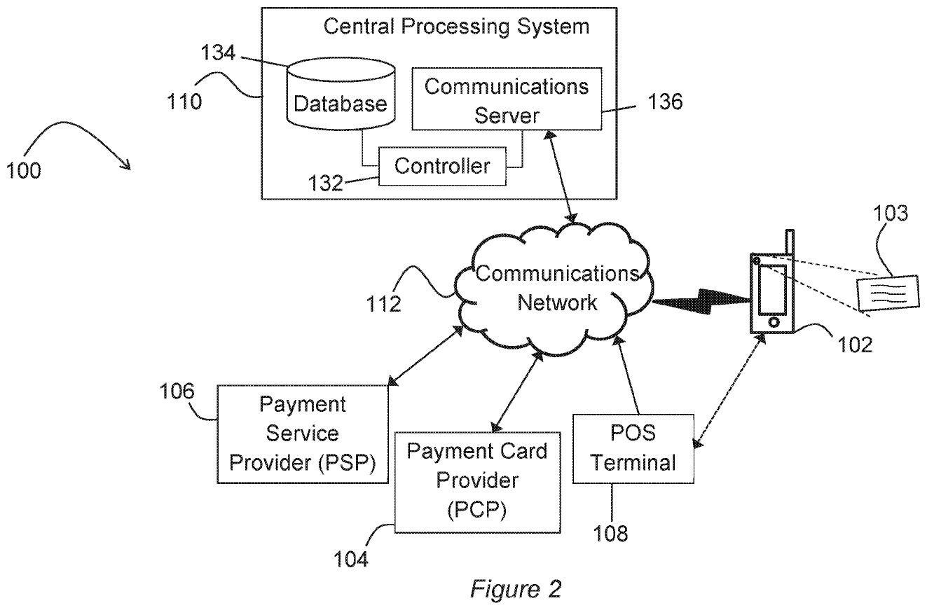

An example system 100 according to an embodiment of the invention is illustrated in FIG. 2. The system 100 is configured to control the display of representations of payment cards in a digital wallet application of an electronic device 102, thereby providing improved graphics for payment card representations in the digital wallet.

The system includes: an electronic device 102 that acts as a digital wallet; at least one payment card provider (PCP) 104; at least one payment service provider (PSP) 106; at least one point of sale (PoS) terminal 108; and a central processing system 110. Here the PCP 104 and the PST 106 are servers providing the required electronic communications to interact with other components of the system according to standard protocols or protocols described herein.

Each of the electronic device 102, PCP 104, PSP 106, PoS terminal 108 and central processing system 110 is connected to and/or capable of communication with a communications network 112. The communications network 112 is generally a wide-area network such as the Internet, for example, which connects various parties involved in the implementation of the embodiment and provides network infrastructure for the exchange of data.

It will be appreciated that other systems may be connected via the communications network, such as an acquirer and/or payment schemes. For simplicity, acquirers are not discussed herein. Payment schemes may be considered as part of the PSPs 106, or where references to the PSPs 106 are made, the reference can also be taken as a reference to the payment scheme as well or alternatively. Although the methods below are described in relation to a PSP 106, the methods may also be applied using a payment scheme computer system in place of the PSP 106.

As shown by the dotted arrow between the electronic device 102 and the PoS terminal 108, the PoS terminal 108 and electronic device 102 are also capable of communicating. The communication between the PoS terminal 108 and the electronic device 102 is via a near-field communication (NFC) protocol or another short-range wireless communications protocol. References to NFC herein should be regarded as being a reference to the NFC protocol or to any other suitable short-range wireless communication protocol.

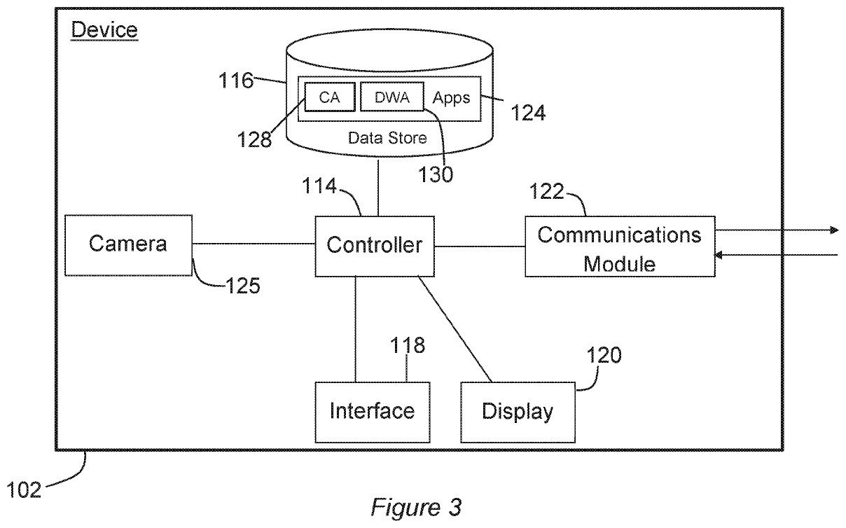

The electronic device 102, an example of which is shown in FIG. 3, is typically a mobile telecommunications device, such as a smartphone or a tablet computer. The electronic device 102 belongs to a respective user and is connected to the communications network 112 in order to upload data for processing to a management server according to a method as described herein.

As can be seen in FIG. 3, the electronic device 102 includes a controller 114. The device 102 also includes a data store 116, an interface 118, a display 120 and a communications module 122, each of which are connected to the controller 114 for communication therewith. The interface 118 may be integral with the display 120, for example, as a touch screen. The device 102 also has a camera 125 that is in communication with the controller 114.

The controller 114 is configured to receive inputs from each of the data store 116, interface 118, camera 125, and communications module 122, perform actions such as running applications and processing the inputs, and to output control signals to the camera 125, communications module 122, and display 120. The communications module 122 is operable to facilitate exchange of data with other processing elements shown in FIG. 2 via the communications network, or with the PoS terminal 108 via NFC, and so is capable of receiving data and communicating it to the controller 114, as well as receiving output data from the controller 114 and outputting it from the device 102 to the communications network 112 or PoS terminal 108.

A digital wallet application 124, 130 (such as Apple Pay® or Google Pay®) and consumer application 124, 128 are also stored within the data store 116. The consumer application and digital wallet application 124, 128, 130 are both depicted in FIG. 3 as being an ‘app’ 124 in the data store 116. The consumer application 128 and digital wallet application 130 are both installed on the device 102 so that they are stored in the data store 116 and executable by the controller 114 when required. The digital wallet and consumer applications 128, 130 are downloadable from an application store and/or content provider. For example, the content provider may comprise the Apple Appstore® or Google Play®. Particularly, the digital wallet and consumer application 128, 130 are operable in combination to allow personalisation or update of existing graphics associated with payment cards enroled in the digital wallet application 130 as will be described in more detail below.

The consumer application 128 comprises an application interface that is used to gather data from the user, particularly relating to user preferences, and to display data sent to the application 128 by the central processing system 110 via the communications network 112. For example, the consumer application 128 may gather card information using the device camera 125 as shown in FIG. 2. When the consumer application 128 is run by the controller 114, data is displayed to the user and data input to the device via the interface 118 is interpreted according to the setup of the consumer application 128.

Data input to the consumer application 128 by the user can be uploaded via the communications network 112 to a centralized hub such as the central processing system 110 where it can be managed and processed, and responded to, by the central processing system 110.

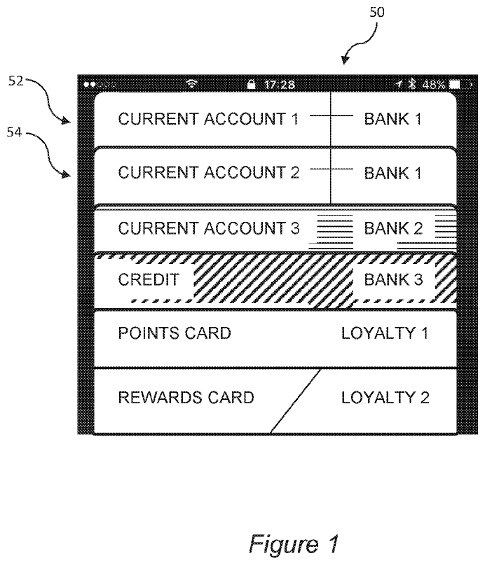

The digital wallet application 130 is an application used by the user of the electronic device to perform transactions with PoS terminals 108 without the necessity for a physical payment card or token. The user registers a payment card or token with the digital wallet application 130 by inputting details of the physical payment card such as payment account number (PAN) and expiry date, and accepts the policies of the particular digital wallet application. The user gives consent for the digital wallet application 130 to use the details they have provided to perform interactions with other NFC-enabled devices in order to complete transactions from the user's bank account to the bank account of a merchant, when the user consents. The digital wallet application 130 may contain a plurality of registered payment cards. Each payment card is represented using a payment card image. If multiple payment cards and/or other user tokens, such as event tickets or loyalty cards, are registered with the digital wallet application 130, they are represented in list form, such as that shown in the ‘wallet’ 50 of FIG. 1, with each card being represented by part of an image of that card within a wallet style GUI. One of the registered payment cards or tokens, which has been selected by the user to be the default payment card, is displayed at the top of the list (GUI).

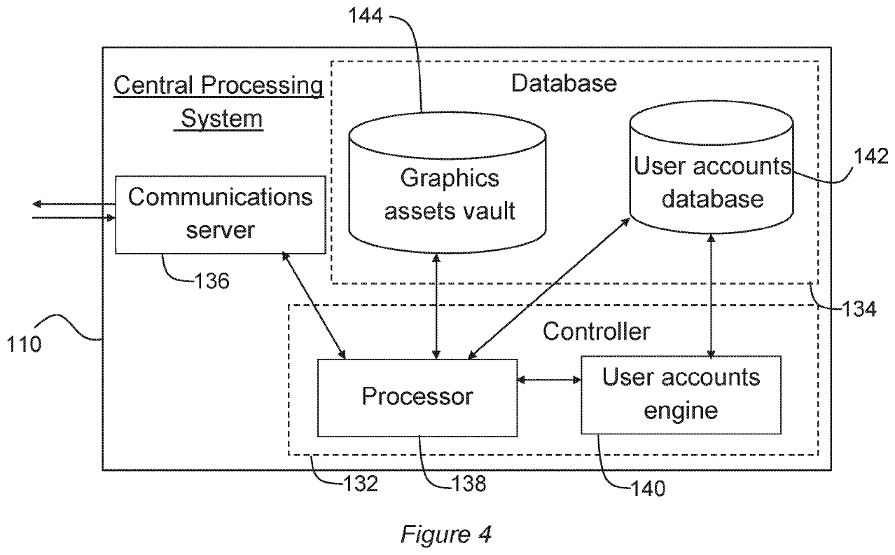

To initiate an interaction, the user accesses the digital wallet application 130 via the interface 118 and display 120, either using a shortcut specifically designed for initiating an interaction (for example by double clicking a physical button of the device 102), or by navigating through the operating system of the device 102 and commanding the controller 114 to run the digital wallet application 130. The specific implementation of the interaction is described later with reference to FIG. 4.

Once the user has initiated the interaction, the device 102 can be brought close to an NFC reader, for example at the PoS terminal 108. The device 102 and NFC reader communicate using the NFC protocol, transferring the relevant information for a transaction to be performed. The transaction in this case is an authorisation communication from the PoS terminal 108 to the PSP 106 to authorise a transaction regarding a given payment card which is identified by its PAN. The PoS terminal 108 and the device 102 subsequently notify the user when the interaction is complete.

The digital wallet application 130 and consumer application 128 may be integral as a single application configured to perform both functions.

Returning briefly to FIG. 2, the central processing system 110 receives data sent via the communications network 112 and provides data to other systems connected to the communications network 112. The central processing system 110 comprises a communications server 136, a controller 132, and a database 134. Data is received at the central processing system 110 by the communications server 136 and processed by the controller 132, which is operatively coupled with the database 134. Data that is received by the communications server 136, or data that is of use for the operation of the controller 132, may be stored in the database 134. The central processing system 110 is external to the consumer application and acts as an on-demand service.

It will be appreciated that references to communications by the PSP 106 and PCP 104 are enacted by respective communications modules housed within computer systems of the PSP 106 and PCP 104 respectively. The computer systems, typically servers, process authorisation requests, control access to user databases, compare authorisation requests with user databases, communicate with each other and other parties to the system, and communicate authorisation responses. The PSP 106, as will be discussed later on, is in communication with the central processing system 110 directly and may also be in communication with the user's electronic device 102 directly, via, for example, one or more application programming interfaces at the PSP 106.

FIG. 4 illustrates the central processing system 110 in greater detail. As shown in FIG. 2, the central processing system 110 includes the communications server 136, the controller 132, and the database 134. The controller 132 comprises a processor 138 and a user accounts engine 140. Together, the processor 138 and user accounts engine 140 are configured to register individual users and their associated devices 102, to process the preferences selected by a user using the consumer application, to identify the user information initially, to pass the information to a user accounts database 142, and to build a profile of the user based upon preference information. These processes may be performed by either engine 140 or processor 138 forming the controller 132, or may, in other embodiments, be performed by additional engines forming part of the controller 132.

It should also be noted that the database 134 of the central processing system 110 comprises two separate sections: a graphic assets vault 144 and a user accounts database 142. The graphic assets vault 144 contains information relating to graphics that may be selected by a user for display in a digital wallet, while the user accounts database 142 contains specific information relating to each user such as the payment cards and/or tokens registered using the application, a user profile and enrolment information, and the user's preference information.

Although not depicted in FIG. 4, the communications server 136 may comprise an encryption engine for encrypting data before it is communicated, a decryption engine for decrypting encrypted data communicated to the central processing system 110, and a notification engine for generating signals and/or commands to be communicated to the electronic device 102.

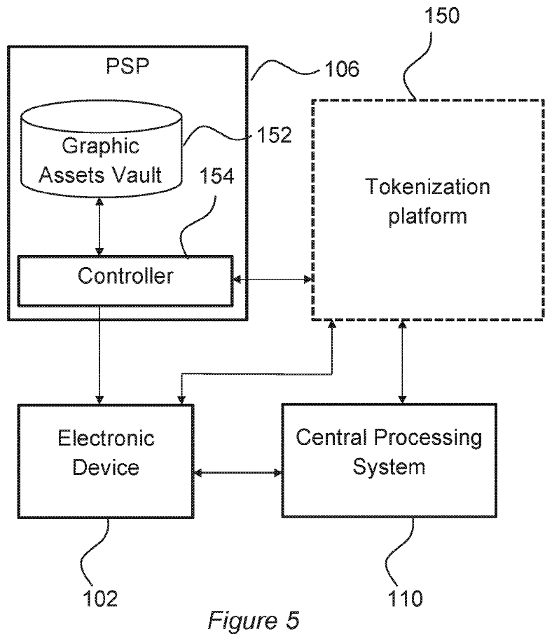

FIG. 5 illustrates the relationship between the central processing system 110, the electronic device 102, one PSP 106, and a tokenization platform 150. As can be seen in FIG. 5, the PSP 106 comprises a graphic assets vault 152 and a controller 154. The graphic assets vault 152 is in communication with the controller 154, which is in turn in communication with the electronic device 102, via the communications network 112 (not shown in FIG. 5).

The tokenization platform 150 is able to receive data from and send data to both the electronic device 102 and the central processing system 110 via the communications network 112 and/or any intermediate systems. In some embodiments, the tokenization platform 150 may be part of the PSP 106. The tokenization platform 150 is also capable of communicating with the controller 154.

Referring now to FIGS. 2 to 5, the initial process of downloading the application, installation and registration of a user will be described. Following this, the process relating to the user's image preferences being displayed in the digital wallet application will be described.

The user initially downloads the consumer application 128 to their electronic device 102 and installs the consumer application. Installation allows the consumer application 128 to interact with and control the device to perform its required function, when the consumer application is run on the device controller 114.

After installation of the application, the user registers personal details using the application interface of the consumer application 128. These details are used for identification purposes and for subsequent authentication requests.

The details are encrypted by the consumer application/electronic device 102. The details are communicated to the central processing system 110, which receives the details at the communications server 136 via an application programming interface (API, not shown). The communications server 136 decrypts the details and passes them to the controller 132 to allow a user profile to be created in the database 134. If a user profile already exists for that user, the existing profile may be updated instead. Although only a single electronic device 102 is depicted here, it will be appreciated that more than one electronic device will be able to communicate with the central processing system 110 via the communications network 112 at any time.

As the central processing system 110 is an on-demand service, the electronic device 102 requires a connection to the communications network 112, such as an internet connection, for the user to be able to interact fully with the application. Where a device 102 cannot connect to the central processing system 110, then the application is still able to perform much of its functionality with only locally cached media. It is noted however that, when the device 102 is unconnected to the communications network 112, changes to preferences are not saved to the relevant database 134 and so these changes may not persist in such a situation, or may only persist once the device 102 is reconnected to the communications network 112.

When a connection to the communications network 112 (i.e. an Internet connection) and connection to the central processing system 110 are established, the personal details of the user are encrypted using an encryption engine (not shown) of the device 102 and persisted in the user accounts database 142, as described above. In the event of no connection being available, the user will not be able to register to the service.

The process of enrolment of a user, and the process relating to the user's image preferences will now be described with reference to FIGS. 2 to 5.

After registration, the user can enrol at least one payment card with the consumer application 128. The payment card may be enroled based on an existing payment card in an existing digital wallet application 130 (if the consumer application 128 is integrated or capable of interaction with the digital wallet application 130) or the payment card may be enroled based on a scan of or manual entry of data on the payment card. The payment card may be a new payment card, and the consumer application 128 may have the functionality to enrol the payment card in the digital wallet application 130, optionally simultaneously and automatically.

To enrol the at least one payment card, at least a Primary Account Number (PAN) for the card, and optionally an expiry date and/or other account or card details, are provided as inputs. To register that payment card with the system, the user's consent to the terms of service of the system is requested in a two-stage agreement. When consent and a network connection is present, the encrypted card information is securely transferred from the device to the tokenization platform 150 via the communications network 112.

The transference of payment card data to the tokenization platform 150 may also be via the central processing system 110, although the central processing system 110 is not be able to decrypt the encrypted card information, as this information may only be decrypted by parts of the system having compliance with the correct regulation, such as the tokenization platform 150 or the PSP 106.

At its tokenization platform 150, the PAN and any other card information is received and a card identifier (CID) is generated. The PAN and other card information is then stored in a card data vault (not shown) associated with the tokenization platform 150. The CID is a non-sensitive data equivalent used to refer to the card so that reference can be made to it without any sensitive information being transferred via non-encrypted communications. The tokenization platform 150 encrypts and securely returns the CID back to the electronic device 102. The CID may also be referred to as a token.

The CID, at least, is subsequently transferred from the consumer application 128 operating on the electronic device 102 to the central processing system 110. At this point, the consumer application 128 may communicate additional data such as user-specific data or assets, although it will be appreciated that this information may be communicated to the central processing system 110 by the electronic device 102 at any time.

The central processing system 110 confirms to the electronic device 102 that the data has been received. A confirmation may be communicated to the user.

Once the central processing system 110 has received the CID at its communications server 136, the user accounts engine 140 of the central processing system 110 is configured to store the CID in the user accounts database 142 for subsequent use.

The card enrolment process is then complete, and the user is prompted to enrol more cards, in which case the process repeats until the user has finished enroling payment cards.

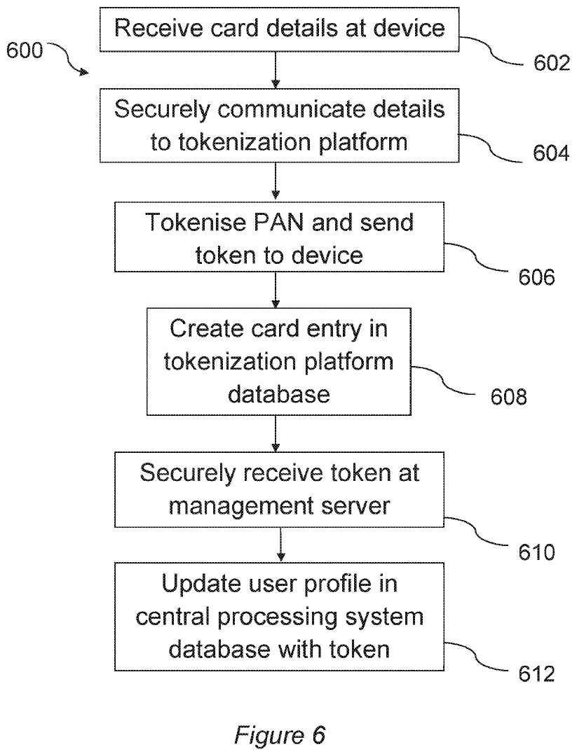

In general, therefore, the card enrolment process 600 is performed according to the flow chart of FIG. 6. The process 600 comprises the steps of: receiving card details at the electronic device, at Step 602; securely communicating the details to a tokenization platform, at Step 604; tokenizing the PAN to receive token/CID and sending the token back to the device 102, at Step 606; creating a card entry in the tokenization platform 150 using the token and PAN to enable look-up, at Step 608; securely receiving the token at the central processing system, at Step 610; and updating a user profile with the token and any other relevant card data, at Step 612.

Having enroled a payment card, user preference data for that card can be specified. The user may specify image preference data for their enroled payment card or cards. The user may specify image preference data based upon graphic assets stored in the graphic assets vault 144 of the central processing system 110, or may specify images stored on the electronic device 102.

The electronic device 102 encrypts the preference information before communicating it to the central processing system 110, where it is passed from the communications server to the controller 132 of the central processing system 110. The controller 132 utilizes the preference information to update the user's profile in the user accounts database 142 and to access the relevant graphics data that corresponds to the user's preference in the graphics assets vault 144 of the central processing system 110. If this is successful, the communications server 136 issues a confirmatory response to the electronic device 102.

The graphics data retrieved from the graphics assets vault 144 of the central processing system 110 may be in the form of complete image data, or may comprise an asset ID number or other metadata to allow the device 102 to retrieve the correct asset using the ID number/metadata when required.

Having retrieved the graphics data from the graphics asset vault 144 of the central processing system 110, the controller 132 passes the graphics data and CID to the communications server 136. The communications server 136 transfers the graphics data and CID to the tokenization platform 150. The tokenization platform 150 receives the CID and graphics data, and accesses the PAN to which the CID relates. The tokenization platform 150, which is provided by a token service provider, returns a success or failure message to the central processing system 110.

The tokenization platform 150 then passes the PAN and graphics data to the PSP 106 controller, which identifies the payment card that corresponds to the PAN and the current graphics data in the graphic assets vault 152 of the PSP 106. The PSP graphic assets vault data for that card is then overwritten by the controller 154 using the PAN and new graphics data.

Then, when the electronic device 102 running the digital wallet application 130 next communicates with the PSP 106, either when the digital wallet application 130 is opened or at a predetermined point, asset information is communicated to the electronic device 102 from the PSP 106. The communication of the asset information may be in the form of a push notification, or based on polling. The electronic device 102 receives the asset information, such as metadata allowing the image to be identified.

The asset information may be image data, a location within the PSP graphic assets vault 152 from which the digital wallet application 130 is required to download the information, a location within the graphic assets vault 144 of the central processing system 110, or an image stored by the consumer application in the device data store 116. Regardless of where the image is sourced from, the asset information received by the electronic device allows the electronic device 102 to access and retrieve the image from its location, either through communication with the central processing system 110, tokenization platform 150, or PSP 106, or by retrieving the image internally.

The digital wallet application 130 subsequently updates the graphics associated with the card in the list, and the representation of the physical token in the digital wallet reflects the user-selection. The user will see the new payment card graphics, or card art, when they access the card in the digital wallet application.

Considering FIG. 5 once more, the flow of information can be considered to follow the steps listed below:

1. Payment card is enroled via consumer application 128 on the electronic device 102.

2. PAN and payment card data is sent to the tokenization platform 150 of the PSP 106 via a secure, restful API.

3. Card details are stored in a Card Data Vault 144 associated with the tokenization platform 150.

4. Token (CID) (encoded token identifier) and payment card data returned to electronic device 102 in an HTTPS response.

5. Token and payment card data is communicated to the central processing system 110 via the communications network 112.

6. Token and payment card data is persisted in the database 143 of central processing system 110.

7. Pre-approved graphics are delivered to consumer application 128 by a secure RESTful API from the graphics assets vault 144 of the central processing system 110.

8. User selects one or more graphics and specifies any other preference information for one or more enroled payment cards.

9. User selection and preference information is communicated to the central processing system 110.

10. User selection and preference information is persisted in the database 134 of the central processing system 110.

11. Central processing system sends a Card Metadata Update Notification (instruction) including token and graphic asset information to the tokenization platform 150 (also referred to as proxy pass-through service) to update the graphics data associated with the payment card within the PSP graphics assets vault 152.

12. The token is replaced by the PAN, this together with the graphic asset information updates the graphics associated with that PAN in the PSP graphic assets vault 152.

13. When the digital wallet application 130 updates its metadata for enroled payment cards, the asset data for the chosen graphics are displayed on the relevant payment card or cards.

The images are pre-approved by the payment service provider or scheme, or by the payment card provider (PCP) 104. Although it is possible for users to submit their own images, the image providers maintain control of what may be used as card art, so there may have to be pre-approval before an image can be used.

The user is able to select a pre-approved image in a number of ways. For example, a thumbnail of each pre-approved image may be provided through the consumer application. In alternative embodiments, or additionally, the user may scan the physical card using the device camera 125, and a suitable protocol such as cardio or other card scanning software may recognise the card and identify the art on the face of the physical card. Matching software may then find the relevant art in the pre-approved image database, and communicate this to be used as the new card art.

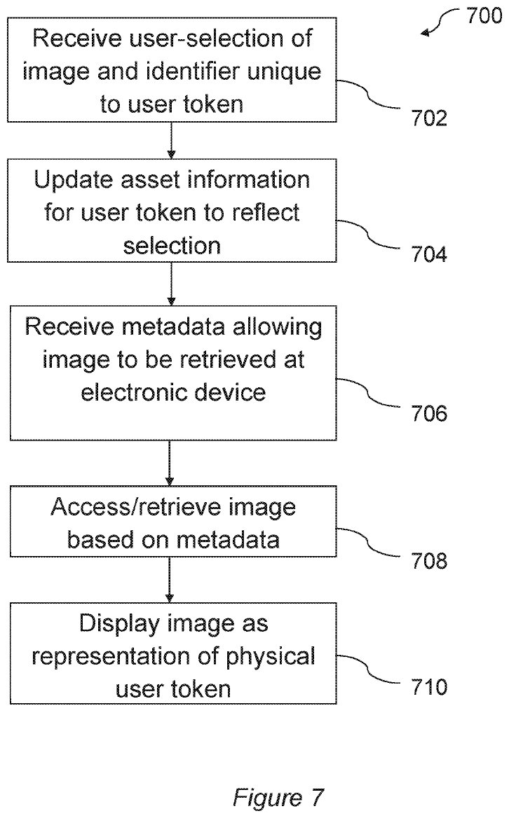

More generally, the system operates according to the process 700 of FIG. 7. The process 700 commences with the processing system 110 receiving a user selection relating to an image and an identifier that is unique to the user token, at Step 702. In the above embodiments, the user token is the payment card and the unique identifier the PAN or tokenized PAN of the payment card. The process 700 comprises: updating, in a central data store remote from the electronic device, i.e. the vault 152 of the PSP 106, graphic asset information associated with the user token based on metadata identifying the user-selected image and the user token identifier, at Step 704; and, receiving, at the electronic device, the metadata identifying the user-selected image, at Step 706. The process 700 further comprises: accessing the user-selected image based on the metadata identifying the user-selected image, at Step 708; and displaying the user-selected image on the representation of the physical user token in the digital wallet application of the electronic device, at Step 710.

It will be appreciated that the call to Card Metadata Update Notification, which is the way in which information in the PSP graphic assets vault 152 is updated from the central processing system 110, can be made as often as is required to support the user's preferences made in the consumer app, and for this reason, multiple images or graphics may be associated with each payment card in the central processing system. This allows the central processing system to identify when a predetermined condition is met and to automatically send an update notification to the PSP via the tokenization platform 150 to update the payment card graphics data. When the digital wallet application 130 next contacts the PSP 106, the graphics will be updated according to the predetermined condition.

If there are multiple images or graphics associated with a particular payment card, the central processing system may assign each image a unique identifier, and communicate metadata relating to all images and unique identifiers to the PSP 106 for storage. In this embodiment, the central processing system 110 indicates to the PSP 106 which of the stored image references should be used in updating the digital wallet application 130 so that the corresponding image is displayed on the device 102.

Graphics preferences may be updated by the central processing system 110 based on at least one of the following:
date information such that payment card graphics relate to particular events e.g. the user's birthday, a weekly or daily change, public holidays, sports events or music events;
location data of the electronic device;
curated content from an authorised content provider.

The graphics of the payment card may comprise a static image, a movie, or a GIF. In the case of a series of moving images, the image on the payment card may move continually, or may move only when a payment is made, when the digital wallet application 130 is first accessed or when the user interacts with the digital wallet application.

Graphic preference data specified by the user may also relate to the way that the user-specific information (i.e. payment card data) is displayed on the representation of the card in the digital wallet application 130.

It will be appreciated that the provision of a consumer application 128 and a central processing system 110 as described herein for updating images allows the typically closed, legacy systems to have a solution retrofitted to them in order to allow new images to be specified. The central processing system 110 and consumer application 128 dovetail with the electronic device 102 and PSP 106 respectively to enable user preferences to be updated in a straightforward manner without compromising the integrity of the digital wallet or the PSP. As current implementation of images in digital wallets relies on BIN number, which is common to many different payment cards, the use of a payment card-specific identifier permits complete customisation of a payment card within a digital wallet without overhauling the communication between digital wallets and PSPs.

Furthermore, the use of metadata to update the graphic assets vault 152 significantly reduces the data requirements at the PSP 106, and permits graphics from the user's own electronic device or from external locations to be used. The above system also permits control to be retained by the PSP 106 and digital wallet application 130 with regards to particular aspects of the display of payment cards within the digital wallet; the digital wallet application can still maintain important features of the payment cards such as brand information so that users are able to quickly distinguish payment cards from different providers in the list of payment cards in their digital wallet applications. For example important distinguishing features such as Brand and account number can be provided in a portion of the card which will be exposed when presented in the overlapping configuration shown in FIG. 1.

Generally, there is described herein embodiments including a system and/or method for managing the graphic assets applied to payment card representations within a digital wallet. The system may comprise an electronic device such as a mobile telecommunications device that is associated with an end-user. The electronic device may comprise an image sensor such as camera. The electronic device may comprise a processor for processing image data from the sensor and for processing user preference information input to the electronic device by the end-user. The electronic device may comprise a memory for storing processed image and metadata. The electronic device may comprise a telecommunications module operable to download a consumer application. Preferably, the telecommunication module is a wireless telecommunications module. The system may comprise a central processing system configured to receive information from the electronic device relating to graphic assets preferences of the end-user and to communicate with a payment service provider to implement changes in the graphic assets of a digital wallet application stored on the device.

In some embodiments the consumer application may comprise at least one of: a user interface; a registration interface; a ‘wallet’ interface of payment card entries; payment card identification software; a library of available graphics for use on payment card representations in the digital wallet application; a preferences interface for making selections.

The electronic device of some embodiments may be arranged to execute the downloaded application to control the electronic device to carry out at least one function, method and/or operation as per the embodiments described herein.

In some embodiments, the electronic device may be arranged to execute the downloaded consumer application to control the electronic device to perform a set of actions, the set of actions comprising at least one of; Identifying the physical data-bearing media (in this case a physical payment card) using embedded software; identifying a user's card graphics preferences; updating the graphics on a payment card representation to be reflected in a digital payment wallet; applying multiple graphics preferences to a single payment card; creating rules for when graphics updates are triggered.

In several embodiments, the electronic device is arranged to associate with a user account the data extracted from a set of data-bearing media. Advantageously, this enables payment cards and a collection of user-selected graphics to be linked to the same user account, thereby enables user-selected graphical differentiation in the digital wallet.

The application may be sourced from an application store and/or content provider. For example, the content provider may comprise the Apple® Appstore®. The content provider may comprise a cloud computing provider.

In some embodiments the system may further comprise at least one of; a management server comprising at least one of; a management database comprising at least one of a library of graphic assets for payment cards and payment card truncated PAN and token data; a registration module; an encryption module; a decryption module; a payment card provider; an application API; a partner API.

In some embodiments, the system may be configured to perform a method to update the graphics displayed in a user's digital wallet. The method may comprise a combination of a plurality of the following steps: enroling, via consumer application, a payment card on an electronic device; sending, via the electronic device, payment card data to a payment service provider; storing, at the payment service provider, the payment card data in a database; receiving, at the electronic device a token and other relevant payment card data from the payment service provider; communicating, by the electronic device, token and payment card data communicated to a central processing system via a communications network; persisting the token and payment card data in a database of the central processing system; delivering pre-approved graphics from the central processing system to a consumer application operating on the electronic device; receiving, at the central processing system from the electronic device, one or more user-selected graphics and/or user preference information for one or more enroled payment card; persisting the user selection and/or preference information in a database of the central processing system; sending an update notification from the central processing system to the payment service provider to update the card metadata relating to graphic assets for the one or more enroled payment cards; updating the graphic assets associated with the enroled payment card in the PSP graphic assets vault; accessing the graphic assets vault using the digital wallet application; and updating the graphics displayed for the representation of at least one enroled payment card.

It will be understood that features, functions and advantages of this aspect of the present invention may be combined or substituted where context allows. Furthermore, features herein may themselves constitute further aspects of the invention. For example, the application of multiple user-selected graphics to a payment card presented in a digital payment wallet.

1. A method for controlling display of a graphical representation of a physical user token in a digital wallet application of an electronic device, where the graphical representation is specified by a token server of a token-issuing entity, the method comprising:
receiving, at a central processing system, user-specified data from the electronic device, the user-specified data comprising a unique token identifier that represents the physical user token and an image identifier representing a user-determined image associated with the physical token;
linking, at the central processing system, the unique token identifier with the image identifier;
sending an update instruction from the central processing system to the token server, to update graphical asset data associated with the physical user token stored at the token server, the instruction including the image identifier and the unique token identifier,
updating the graphical asset data associated with the physical user token stored at the token server, with the received image identifier and unique token identifier;
transmitting from the token server, asset information relating to the graphical representation to the electronic device, the asset information being generated using the image identifier and the unique token identifier; and
using the received asset information to display the graphical representation in the digital wallet application of the electronic device.

2. The method of claim 1, wherein the receiving step comprises receiving user preference data as the image identifier, the user preference data indicating an image, and the method further comprises obtaining the image identifier based on the user preference data.

3. The method of claim 2, wherein the method further comprises providing a selection of image data at the electronic device and generating the user preference data based on the user selection of image data.

4. The method of claim 1, wherein the receiving step comprises receiving the unique token identifier and obtaining the image identifier based on the unique token identifier.

5. The method of claim 4, wherein the obtaining step comprises comparing the unique token identifier with a library of token identifiers and extracting an image identifier associated with the unique token identifier, the library being external to the central processing system.

6. The method of claim 5, wherein the image identifier represents a pre-approved image forming part of a library of pre-approved images.

7. The method of claim 4, wherein the receiving step comprises receiving image data representing a captured image of the physical user token, and the obtaining step comprises obtaining the image identifier for the captured image using image recognition.

8. The method of claim 1, wherein the linking step comprises storing the token identifier and the image identifier in a data store of the central processing system.

9. The method of claim 1, wherein the linking step comprises updating an existing entry in the data store relating to the token identifier with the received image identifier.

10. The method of claim 1, wherein the linking step comprises determining whether a pre-determined criteria has been met, and if so updating the image identifier in the central data store based on the pre-determined criteria.

11. The method of claim 1, wherein the sending step comprises sending the update instruction to an API of the token server.

12. The method of claim 1, further comprising transmitting the token identifier to a tokenizing platform and receiving an encoded token identifier representing the token identifier.

13. The method of claim 12, wherein the sending step comprises sending the update instruction to the token server via the tokenizing platform, the unique token identifier comprising the encoded token identifier and converting the encoded token identifier into an un-encoded token at the tokenizing platform before transmitting the same to the token server.

14. The method of claim 1, wherein the asset information comprises one of the group comprising an image, a location of the graphical assets stored at the token server and a location of an image stored at the token server.

15. The method of claim 1, wherein the asset information provides a location in an image store of the electronic device and the using step comprises retrieving the image from the image store of the electronic device.

16. The method of claim 1, wherein the asset information comprises a location of metadata and the method further comprises using the metadata to enable the electronic device to retrieve the graphical representation.

17. The method of claim 1, wherein the transmitting step comprises transmitting the asset information to the electronic device via a push notification.

18. The method of claim 1, wherein the transmitting step comprises transmitting the asset information when the digital wallet application is updated.

19. A system for controlling display of a graphical representation of a physical user token in a digital wallet application of an electronic device, where the graphical representation is specified by a token server of a token-issuing entity, the system comprising the electronic device, central processing server and the token server,
wherein the central processing system includes:
a receiver for receiving user-specified data from the electronic device, the user-specified data comprising a unique token identifier that represents the physical user token and an image identifier representing a user-determined image associated with the physical token;
a controller for linking the unique token identifier with the image identifier; and
a transmitter for sending an update instruction to the token server, to update graphical asset data associated with the physical user token stored at the token server, the instruction including the image identifier and the unique token identifier;
the token server being arranged to:
update the graphical asset data associated with the physical user token stored at the token server, with the received image identifier and unique token identifier; and
transmit asset information relating to the graphical representation to the electronic device, the asset information being generated using the image identifier and the unique token identifier; and
the electronic device being arranged to use the received asset information to display the graphical representation in the digital wallet application of the electronic device.
